(19) United States
(12) Patent Application Publication
(10) Pub. No.: US 2005/0141180 A1
(43) Pub. Date: Jun. 30, 2005

(54) Display unit with cord clamper

(76) Inventors: Kouji Umeda, Fukui (JP); Daisuke Shimizu, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/017,887

(22) Filed: Dec. 22, 2004

(30) Foreign Application Priority Data
Dec. 25, 2003 (JP) 2003-430017

(51) Int. Cl. G06F 1/16

(52) U.S. Cl. 361/681; 348/552; 361/682; 345/905; 248/917

(57) ABSTRACT

To provide a display unit which is capable of damping cables and cords as necessary without spoiling the appearance of the display unit, it includes a display and a support for supporting the display, wherein the support comprises at least a column having a cut groove where a cord damper for damping cords and cables to be led to the display is removably fitted, the cord damper being biased inwardly.

### BACKGROUND OF THE INVENTION

1. Field of the Invention

The present invention relates to a display unit such as TVs and PCs and, more particularly, relates to a display unit having a cord damper for damping cords in position.

2. Related Art

Electrical equipment has various cords to transmit electric signals. The cords are tied together with bands so as not to get entangled or not to break down by getting caught in a space between it and another member. The displays of recent TVs and PCs use thin liquid crystal screens, and so require little space when placed on the top of desks in offices and at home, thus becoming convenient.

Power cords and other cables to be led from the main body of a device to such thin display screens are obstructive and spoil the appearance when greatly protruding externally. Thus various cord dampers are used to prevent it. For example, JP-A-2000-347580 discloses “Wiring Treatment Structure for Display Supporting Device”, which has a wire space formed by mounting a detachable U-section cover member in order to house power cords and cables extending from a display in the display arm attractively and safely without breaking, in which the power cords and cables are accommodated compactly with minimum thickness and without interference from biasing means that move with the vertical movement of a parallel link.

However, the cover member is a structural component of a vertical shaft of the arm unit, to which the function of a cord damper has merely been added. In other words, the vertical shaft cannot be formed without the cover member and the space that is formed is conveniently usable as a space for accommodating cords and cables. Accordingly, the wiring space is so small that the number of cords and cables to be accommodated therein is limited and as such, necessary extra cords cannot be accommodated in the wiring space.

Providing extra dampers for cables and cords, which are not originally the components of electrical equipment, depending on the type and form of the electrical equipment often spoils the appearance of the electrical equipment. In short, the extra dampers for clamping cords and cables spoil the appearance.

### SUMMARY OF THE INVENTION

The structure of the conventional electrical equipment for accommodating cables and cords has the foregoing problems, as described above. Accordingly, it is an object of the present invention to solve the problems, thereby providing a display unit having a cord damper combined to the display unit and capable of damping cords and cable easily.

A display unit according to the present invention includes a display and a support for supporting the display. The support includes at least a column. The column has a cut groove. A cord damper for damping cords and cables led to the display is removably fitted in the cut groove. The cord damper is biased inwardly.

Such a structure provides a space for additional cords and cables connected to the display unit by drawing the cord damper from the column. Thus the cords and cables can be clamped easily between the cord damper and the side of the column by the cord damper. When there is no need to clamp the cords and cables, the cord damper is fitted in the cut groove of the column, thus integrated to the column in appearance.

Preferably, the cord damper has a pivot at one end and can turn around the pivot, and a spring for biasing the cord damper in fitted around the pivot. In this case, the cord damper is opened by turning it around the pivot while the cord damper is drawn out from the cut groove.

Preferably, the column includes a solid, substantially semicylindrical supporting column base portion and a substantially semicylindrical half-tube supplementary portion, the cut groove is formed by cutting the supporting column supplementary portion horizontally, and the cord damper is curved in the same shape as the supporting column supplementary portion and has an externally protruding tab at the end.

This column may include a supporting column base portion of which the lower part is cylindrical and the upper part is semicylindrical, and a supporting column supplementary portion the lower part of which is semicylindrical corresponding to the upper half of the base portion, the cut groove may be formed by cutting the supporting column supplementary portion horizontally, and the cord damper may be curved in the same shape as the supplementary portion and have an externally protruding tab at the end.

Alternatively, the column may include guide means, and the cord damper is mounted slidably along the guide means. In this case, the column may include a base portion and a semicylindrical supplementary portion, each of the lower parts is a semicylindrical solid and each of the upper parts is half of a cylindrical tube, and; the cut groove is formed by cutting the supplementary portion horizontally; the cord damper comprises a clamp portion in the same arc shape as the supplementary portion and a slide arm extending straight inwardly so that the whole cord damper forms an L-shape; and the guide means comprises a guide groove and a guide piece parallel with the guide groove formed integratedly on the top faces in the lower parts of the base portion and supplementary portion so that the slide arm slides smoothly.

The column may be cylindrical, the cut groove may extend vertically, and the pivot may be provided at the lower end of the cord damper.

With the display unit according to the invention, cords and cables connected additionally to a display unit can be retained in position with a damper. The cord damper is of pullout type, which is used only when necessary and, is fitted in the cut groove of the column to be integrated therewith in appearance, thus not spoiling the appearance of the display unit.

### BRIEF DESCRIPTION OF THE DRAWING

FIG. 1 is a perspective view of a display unit according to an embodiment of the present invention, as viewed from the front;

FIG. 2 is a perspective view of the display unit with the cord damper opened, as viewed from the back;

FIG. 3 is a perspective view of the display unit with the cord damper dosed, as viewed from the back;

FIG. 4(a) is a plane section diagram of the cord damper in a state before mounted to the column of the display unit;

FIG. 4(b) is a plane section diagram of the cord damper in a state in which the cord damper mounted to the column is dosed;

FIG. 4(c) is a plane section diagram of the cord damper in a state in which the cord damper mounted to the column is opened;

FIG. 5 is a perspective view of the display unit with the cord damper damping cords;

FIG. 6 is an exploded perspective view of a cord damper, showing another mounting structure;

FIGS. 7(a) and 7(b) are plane section diagrams of a cord damper according to another embodiment and its mounting structure;

FIG. 8 is a perspective view of a base portion according to the above embodiment;

FIG. 9(a) is a perspective view of the foregoing cord damper as viewed from the front;

FIG. 9(b) is a perspective view of the foregoing cord damper as viewed from the back;

FIGS. 10(a) and 10(b) are longitudinal sectional views of a cord damper according to still another embodiment and its mounting structure.

### DETAILED DESCRIPTION OF PREFERRED EMBODIMENT

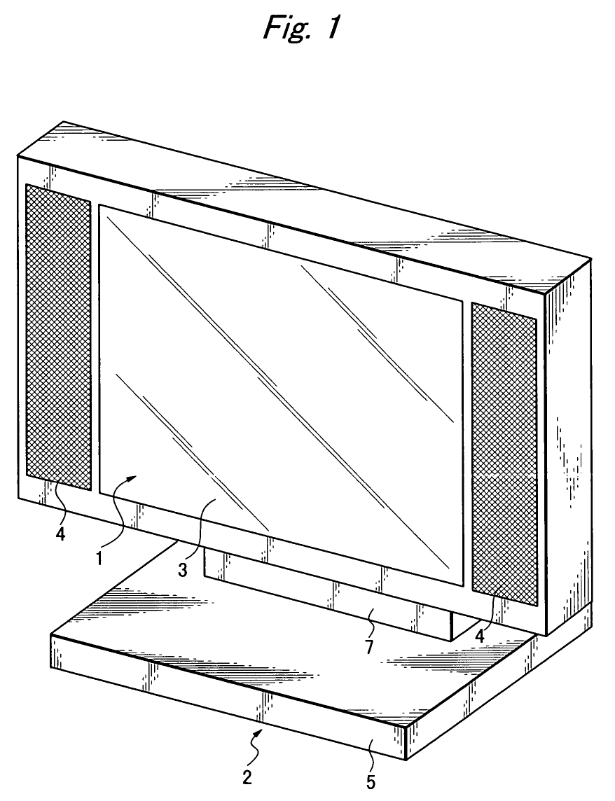

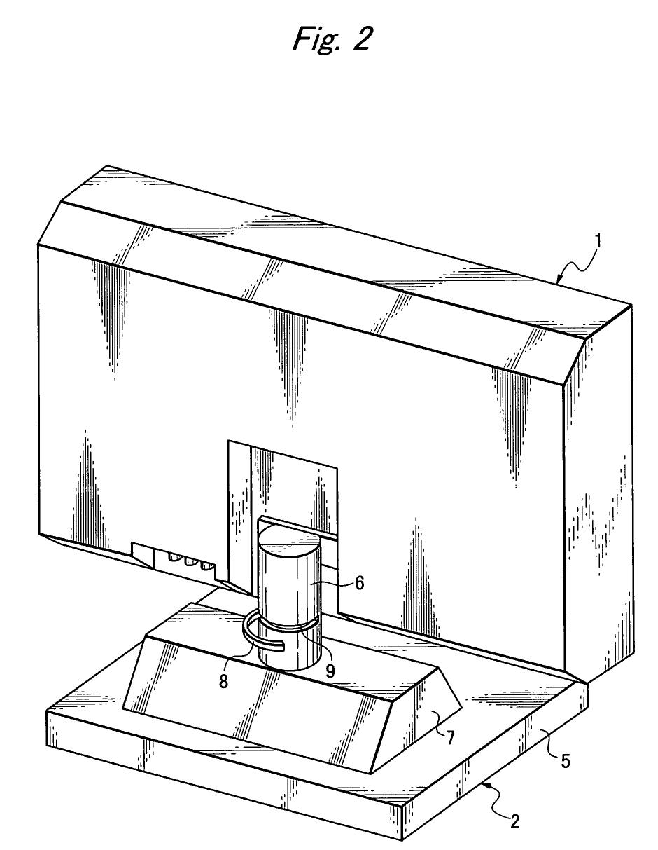

FIGS. 1 to 5 show a liquid crystal television that is a display unit according to an embodiment of the present invention, which has a display 1 and a support 2. The display 1 includes a central screen 3 and speakers 4 disposed on both side thereof. The support 2 includes a base 5 of a size large enough to prevent the toppling of the display unit and a column 6 rising therefrom (refer to FIG. 2). The display 1 is mounted to the upper end of the column 6 such that the angle can be freely adjusted.

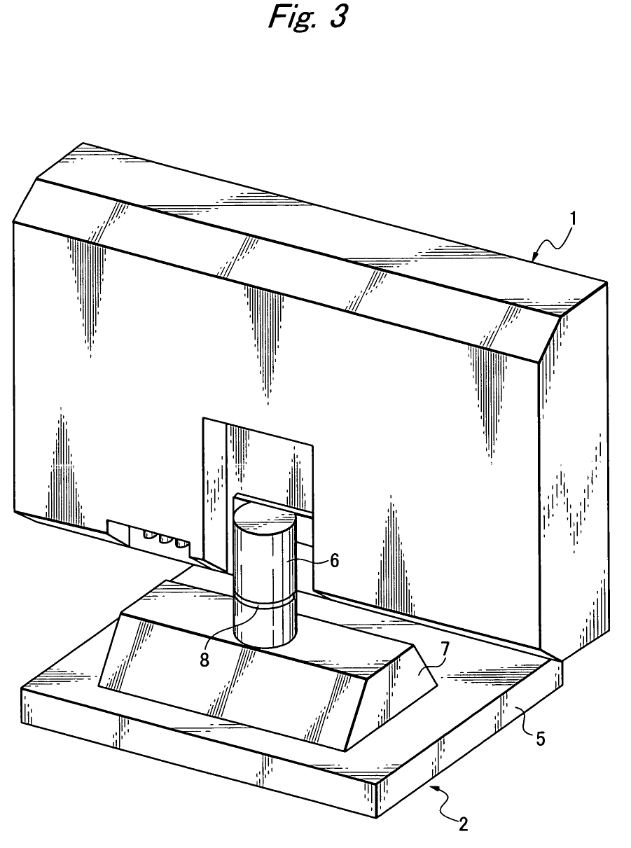

The support 2 is constructed such that the supporting column 6 rises vertically from the rectangular base 5. The column 6 has a trapezoidal-section base 7 at its lower end. To the column 6, a cord damper 8 is combined substantially half around the circumference thereof. FIG. 2 shows a state in which the cord damper 8 is drawn out, in which cables and cords are damped. FIG. 3 shows a state in which the cord damper 8 is embedded in the column 6. Specifically speaking, the column 6 has a cut groove 9, in which the arc-shaped cord damper 8 is accommodated and from which it is drawn out as necessary.

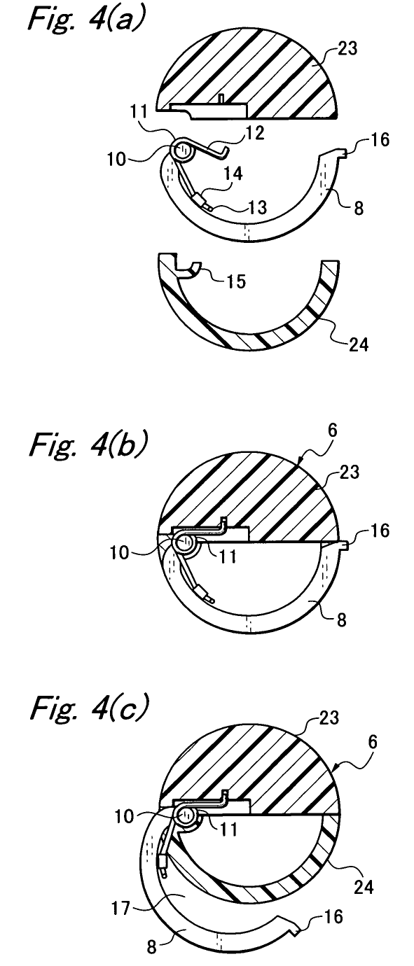

As shown in FIGS. 4(a) to 4(c), the column 6 includes a solid, semicylindrical base portion 23 and a semicylindrical half-tube supplementary portion 24. The cut groove 9 is provided in the supplementary portion 24. The base portion 23 and the supplementary portion 24 of this embodiment are adhered to each other with an adhesive. However, adhering means is not limited to that. The cord damper 8 is curved in the same shape as the supplementary portion 24 and has a pivot 10 projecting upward and downward at a first end, and an externally protruding tab 16 at a second end. A spring 11 is wound around the pivot 10 at the upper end. One end 12 of the spring 11 extends externally from the pivot 10, while the other end 13 extends along the inner circumference of the cord damper 8 and is fixed by a retaining piece 14 formed on the inner circumference.

Two arc-shaped retainers 15 corresponding to the pivot 10 of the cord damper 8 are provided at the upper and lower parts at the first end of the cut groove 9 of the supplementary portion 24. The retainers 15 rotatably support the pivot 10. The base portion 23 has a recess corresponding to the spring 11, in which a hole is provided for the end of the spring 11 to fit in. The spring 11 is biased in the direction to draw the cord damper 8 inwardly so that the cord damper 8 is accommodated in the cut groove 9, and at that time it aligns with the outer circumference of the supplementary portion 24 (refer to FIG. 4(b)).

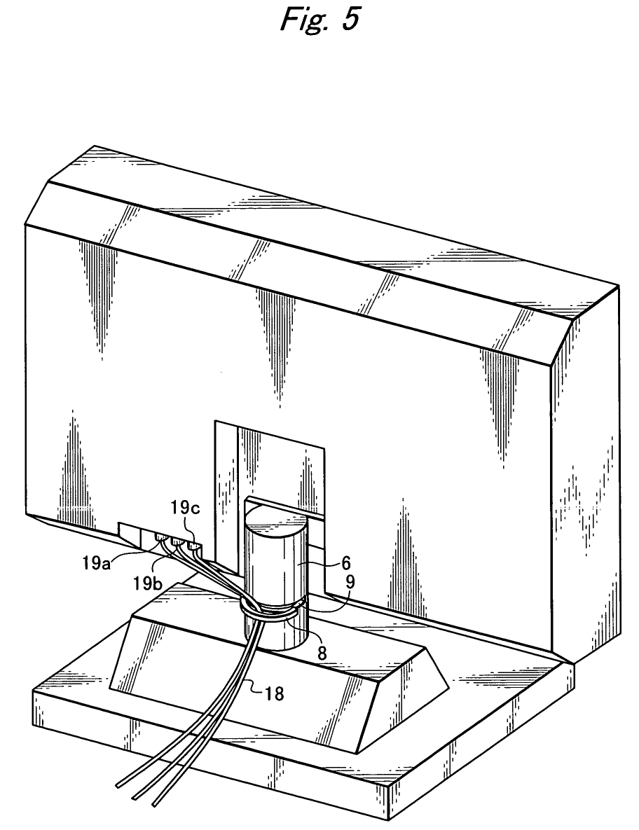

The cord damper 8 when not damping cords comes into the state shown in FIG. 4(b) by the biasing force of the spring 11. To clamp cords, the cord damper 8 is opened with the tab 16 and turns around the pivot 10 to form a space 17 between it and the column 6, as shown in FIG. 4(c). Thus, cables and cords can be clamped in the space 17 and bundled by the curved cord damper 8. FIG. 5 shows a case in which three cords 18 are clamped by the cord damper 8 with such a structure. The cords 18 connected to terminals 19a, 19b, and 19c on the back of the display are bound to the column 6 and prevented from spreading out.

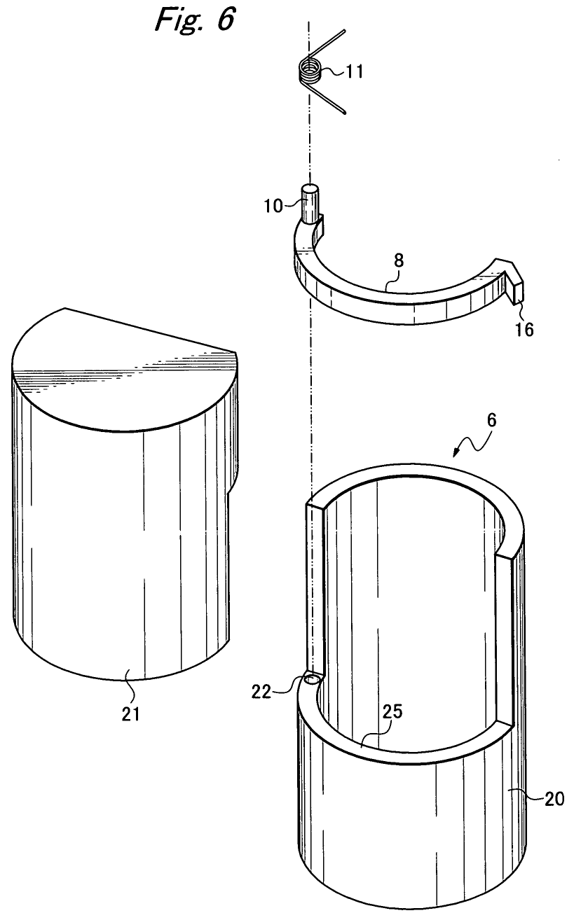

FIG. 6 shows another mounting structure of the cord damper 8. The column 6 includes a base portion 20 of which the lower part is a cylindrical tube and the upper part is half of a tube and a supplementary portion 21 of which the lower part is semicylindrical corresponding to the upper half of the base portion 20 and part of the cylindrical tube portion is cut off. In short, a cylindrical column 6 is formed by combining the lower part of the semicylindrical supplementary portion 21 with the semicylindrical upper part of the base portion 20. The cord damper 8 has an arc shape like the supplementary portion 21, and has a pivot 10 projecting upward and downward at one end and an externally protruding tab 16 at the other end. The pivot 10 has a spring 11 wound therearound.

A pivot hole 22 is provided at the lower part of the upper surface of the base portion 20, in which the lower end of the pivot 10 of the cord damper 8 is fitted. The supplementary portion 21 has a pivot retainer (not shown) at the lower end, as with the first embodiment, to rotatably support the upper pivot 10 of the cord damper 8. Accordingly, the cord damper 8 can be turned around the pivot 10 and so can be drawn out with the tab 16.

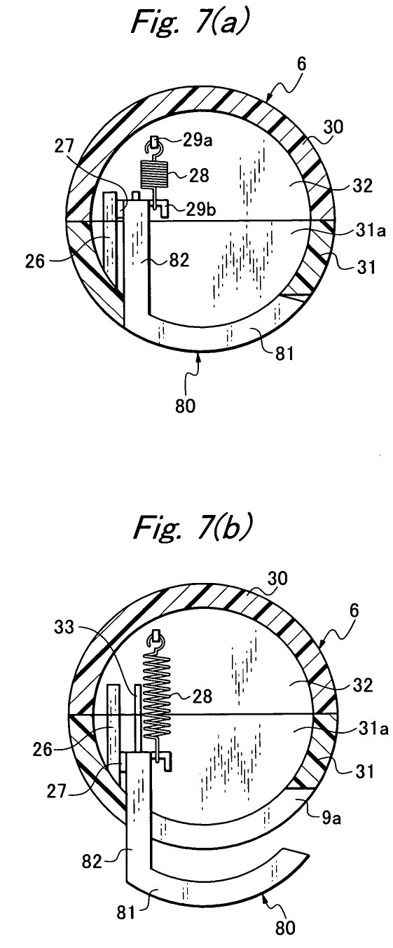

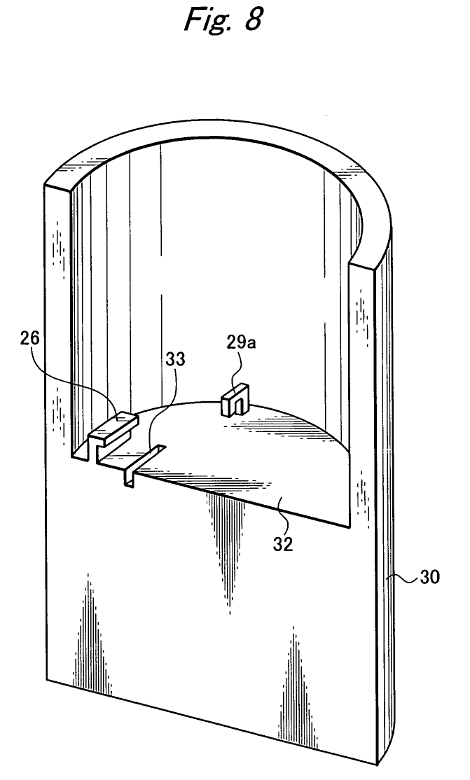

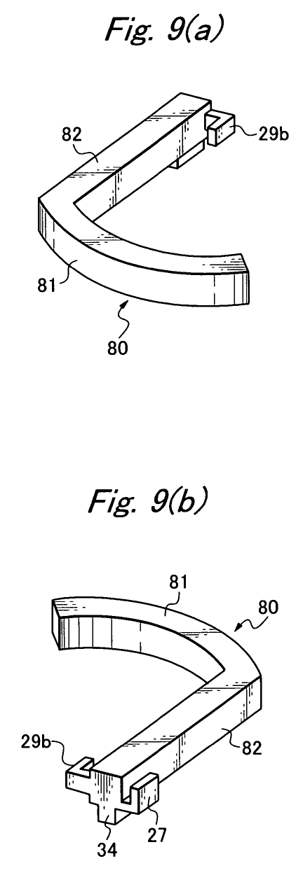

FIGS. 7(a) to 9(b) show another embodiment of the invention. The columnar column 6 includes a base portion 30 and a supplementary portion 31, both of which the lower halves are semicylindrical solid and the upper halves are semicylindrical tubes (refer to FIG. 8). A cord damper 80 is different in shape from the first embodiment, and is formed of a clamp portion 81 of an arc shape as same as the semicylindrical supplementary portion 31 and a slide arm 82 extending straight inwardly so that the whole clamp portion is in an L-shape. Between one end of the cut groove 9a of the supplementary portion 31 for the clamp portion 81 to fit in and the end of the cord damper 80, small clearance is provided in which the tip of a finger can be caught (refer to FIG. 7(a)).

As shown in FIGS. 7(a) and 7(b), the cord damper 80 is biased inwardly by a coil spring 28, the ends of which are retained respectively by a retaining piece 29b that is part of the slide arm 82 of the cord damper 80 and by a retaining piece 29a provided on the top face 32 of the lower half of the base portion 30. The top face 32 of the lower half of the base portion 30 and the top face 31a of lower half of the base portion 31 are in one plane, and a guide groove 33 is formed through both the top faces 32 and 31a. Also, a guide piece 26 is provided parallel to the guide groove 33 through on both the top faces 32 and 31a. The slide arm 82 of the cord damper 80 has a sliding piece 34 at the bottom which is slidably fitted in the guide groove 33, and a regulating piece 27 extending from the side of slide arm 82 which is slidable between the lower part of the top face 32 of the base portion 30 and the lower surface of the guide piece 26 so that the slide arm 82 of the cord damper 80 slides smoothly without vertical rattle.

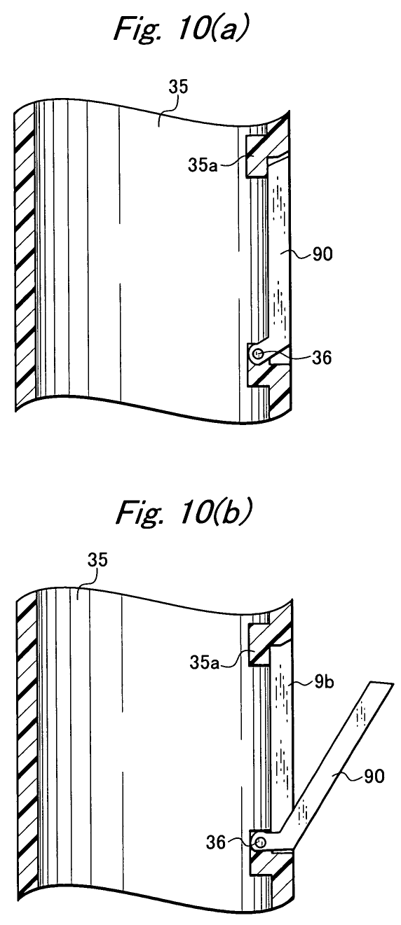

FIGS. 10(a) and 10(b) show still another embodiment of the invention, in which a vertical cut groove 9b is provided in a cylindrical column 35, and the cord damper 90 is fitted in the vertical cut groove 9b. The lower end of the cord damper 90 turns on a pivot 36 provided on the column 35 and the cord damper 90 is biased inwardly by a spring (not shown) wound around the pivot 36. The rotating end of the cord damper 90 is stopped by a stopper piece 35a provided on the column 35 so that the outer circumference of the column 35 and the outer side of the cord damper 90 are flush with each other. Also, there is such a small clearance between the end of the cord damper 90 and the upper end of the cut groove 9b that the tip of a finger can be inserted (refer to FIG. 10(a)). Thus, the cord damper 90 can be drawn out by pinching that end and, when released, the cord damper 90 is accommodated in the cut groove 9b by the biasing force of the spring. When the cord damper 90 is in its opened state, it can clamp cords and cables.

1. A display unit comprising a display and a support for supporting the display, wherein the support at least comprises a column having a cut groove where a cord damper for damping cords and cables to be led to the display is removably fitted, the cord damper being biased inwardly.

2. The display unit according to claim 1, wherein the cord damper has a pivot at one end and can turn around the pivot, and a spring for biasing the cord damper in fitted around the pivot.

3. The display unit according to claim 2, wherein the column comprises a solid, substantially semicylindrical base portion and a substantially semicylindrical half-tube supplementary portion; the cut groove is formed by cutting the supplementary portion horizontally, and the cord damper is curved in the same shape as the supplementary portion and has an externally protruding tab at one end.

4. The display unit according to claim 2, wherein the column comprises a base portion, the lower part of which is cylindrical and the upper part of which is semicylindrical, and a supplementary portion, the lower part of which is semicylindrical corresponding to the upper half of the base portion; the cut groove is formed by cutting the supplementary portion horizontally, and the cord damper is curved in the same shape as the supplementary portion and has an externally protruding tab at one end.

5. The display unit according to claim 1, wherein the column comprises guide means, and the cord damper is mounted slidably along the guide means.

6. The display unit according to claim 5, wherein the column comprises a base portion and a semicylindrical supplementary portion, each of the lower parts is a semicylindrical solid and each of the upper parts is half of a cylindrical tube, and; the cut groove is formed by cutting the supplementary portion horizontally; the cord damper comprises a clamp portion in the same arc shape as the supplementary portion and a slide arm extending straight inwardly so that the whole cord damper forms an L-shape; and the guide means comprises a guide groove and a guide piece parallel with the guide groove formed integratedly on the top faces in the lower parts of the base portion and supplementary portion so that the slide arm slides smoothly.

7. The display unit according to claim 2, wherein the column is cylindrical, the cut groove extends vertically, and the pivot is provided at the lower end of the cord clamper
